(19) United States
(12) Patent Application Publication
(10) Pub. No.: US 2015/0172993 A1
(43) Pub. Date: Jun. 18, 2015

(54) METHOD AND SYSTEM FOR SMARTCALL RE-ROUTING

(71) Applicant: John Yue Jun Jiang, Danville, CA (US)

(72) Inventor: John Yue Jun Jiang, Danville, CA (US)

(73) Assignee: ROAMWARE INC., Cupertino, CA (US)

(21) Appl. No.: 14/237,337

(22) PCT Filed: Aug. 14, 2012
(86) PCT No.: PCT/US2012/050763

§ 371 Date: Jul. 25, 2014

Related U.S. Application Data
(60) Provisional application No. 61/523,768, filed on Aug. 15, 2011.

(51) Int. Cl. H04W 40/20; H04W 8/26; H04M 15/00; H04W 8/04

(52) U.S. Cl. CPC H04W 40/20; H04W 8/04; H04W 8/26; H04M 15/8038; H04M 15/41

(57) ABSTRACT

The present invention provides a method for mobile communication facilitated by a first routing module associated with at a first network that receives call control of a subscribers call to a called number. The first routing module sends the call information of the call from the first routing module to the second routing module. The first routing module further routes the call to an alternative number upon receiving the alternative number from a second routing module associated with a second network. Finally, the second routing module further re-synchs the call to the 10 called number upon receiving call control at the alternative number.

### RELATED APPLICATIONS

This application claims priority from U.S. Provisional Patent Application Ser. No. 61/523,768 entitled “Smart Call Routing” filed Aug. 15, 2011, which is incorporated herein by this reference in its entirety.

### FIELD OF THE INVENTION

The present invention generally relates to mobile communication. More specifically, the invention relates to handling mobile communication while roaming.

### BACKGROUND OF THE INVENTION

Roaming traffic contributes a significant percentage of an operator's revenue and even a better percentage of the operator's margin. With increasing competition and regulatory control, operators are being more pressured to increase their roaming revenue. Over the last few years, revenues to the network operators from home subscribers have consistently declined due to increased competition and resulting pricing pressures. On the other hand, revenues from roamers have consistently grown in the same period due to increased mobile penetration in local markets and an increase in travel.

As the global mobile roaming market business model is evolving, the industry understands the strategic importance of roaming to operator's revenues and profit margins and is adapting various newly proposed regulations. The operators understand that they must develop strategies for driving the number of roamers and roaming usage, while lowering tariff rates.

Amongst the roaming business, the average margins on inbound roaming revenue is around 80% and the average margins on outbound roaming revenue is around 20%. The key challenge lying before the operators is to maximize the outbound roaming revenues. While analyzing the outbound roaming revenues, it should be noted that on an average 40% of the outbound roaming revenues are contributed from Mobile Originated (MO) calls made by outbound roamers. Of these MO calls, almost 70% calls are back home and 10% are to other markets outside the current roaming destination of the subscribers. The revenue earned by the operator from these calls is minimal considering the revenue distribution between the current roaming network of the roamers and the destination network to where the call is made.

The roaming charges levied to a roamer for the outgoing calls made also constitute Inter Operator Tariffs and Retail Markups. The operators are increasingly coming under price pressure to offer better retail rates compared to wholesale tariff. The IOTs carry about 80% margin today whereas retail roaming charges carry only 20% margin. While the operators rely heavily on IOT discounting while setting up roaming agreements to maximize their roaming margins, the exception to the rule is outgoing international calls to other networks, the international outgoing calls continue to be expensive.

The key drivers constituting outbound roaming revenue are hence the Inter Operator Tariff, Termination Rates and Retail Markup. While the operator has little control on retail markup due to competitive pricing, it can leverage incremental revenue streams from the outgoing calls of the outbound roamers by routing the call through

Low cost path thus paying lower IOT

Terminating the calls destined to other networks in the home country in its own network and routing the call to the other network, thus earning the difference in higher international termination and lesser national termination

Current state of art can re-route a call by an outbound roamer via an alternative number of the home network and then reconciles the call at the home network to the original called number. While this can help with CLI delivery and produce some better arbitrage margins, it is not sufficient to deal with many beneficial situations where the alternative routes are not going through a home network number.

In accordance with the foregoing, there is a need in the art of a system, a method, for creating a solution that gives an operator the ways to leverage non-home network call routing such that call made by outbound roamers from the visited network are routed in an optimal manner via a non-home network number, with the aim of maximizing the margin that accrues to the home operator. While the focus of the invention is on roaming, the rerouting methods can be applied similarly to international calls too.

### SUMMARY

The present invention is directed towards a method and system for mobile communication where a first routing module at a first network facilitates routing of a subscriber's MO call to a called party through an alternative number assigned by a second routing module at a second network. This routing is done by the first routing module when the subscriber is present in a visited country or home country and the called party is present in same or different country from the subscriber. In other words, the subscriber initiates either an international or national roaming or long distance call from any network to a called party that may be in a network/country different from the subscriber. The alternative number maybe selected by the second routing module at a second network from either an operator in home country, or an operator in a third country, or a carrier cloud.

The present invention provides a Smart Re-Routing (SRR) service that is a network based solution for outbound roamers, inbound roamers or local subscribers that does not require a handset client application. It uses CAMEL control (as an example, while other call control examples can be SIP, WIN, IN/INAP etc) to turn an outbound roamer's call routing to a called number via an alternative number. Thereafter, when the call control reaches the alternative number, the call control is re-synced back to the called number.

The system and method of the present invention, in its various embodiments facilitate via the routing modules leveraging the arbitrage saving between two routes and also guarantee the quality and CLI of the call.

The system and method of the present invention, in its various embodiments provide the SRR service offering that leverages Roamware's partnership with leading signaling and voice service providers around the world, to re-route the call via a “Re-routing Hub” deployed within the carrier cloud. This re-routing hub can also act as the second routing module. The end-destination of such a call could be the home network or another service provider network within the home country, or a network in a third country. This variation enables the home operator to selectively determine whether a home-based or cloud-based route is most optimal, based on the overall business value taking into account the various cost/revenue elements of either model. The re-routing is achieved through intelligent use of the triggers generated by CAMEL-enabled (or SIP or ISUP or other call control protocols) visited operators back towards the home operator. The user experience for the roaming subscriber is not affected in any way, and he continues to enjoy normal roaming service while traveling.

While the example and focus will be on outbound roaming where the first routing module is associated with the home network where the call control is handled, the invention can be similarly applied to inbound roamers and local subscribers, in which case, the first routing module will be associated with the network where the call is originated and call control is handled. In both cases, the first routing module is associated with the network the call control is intended to be handled by the first routing module.

### BRIEF DESCRIPTION OF DRAWINGS

In the drawings, the same or similar reference numbers identify similar elements or acts.

FIG. 1 illustrates a system for implementing Smart Re-Routing (SRR) service, in accordance with an embodiment of the present invention;

FIG. 2 represents a flowchart depicting method for enabling mobile communication using the SRR service, in accordance with an embodiment of the present invention; and

FIG. 3 represents the system for implementing SRR service using carrier cloud re-routing, in accordance with an embodiment of the present invention.

### DETAILED DESCRIPTION

In the following description, for purposes of explanation, specific numbers, materials and configurations are set forth in order to provide a thorough understanding of the present invention. It will be apparent, however, to one having ordinary skill in the art that the present invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the present invention. The appearance of the phrase “in an embodiment”, in various places in the specification, does not necessarily refer to the same embodiment.

The present invention provides a system and a method for facilitating mobile communication for a subscriber of a Home Public Mobile Network (HPMN) roaming in a Visited Public Mobile Network (VPMN). In accordance with various embodiments, the present invention provides a method and system re-routing a subscriber's MO call to a called party using a first routing module associated with at a first network that facilitates routing of a subscriber's MO call to a called party through an alternative number that is assigned by a second routing module at a second network. The first network is the network from where the subscriber makes the MO call (either home network or visited network). The second network could be a network either in carrier cloud or third country or visited network. The first routing module is deployed in the first network, while the second routing module is deployed in the second network. This concept of re-routing MO call through the alternative number is hereinafter referred to as Smart Re-Routing (SRR) service.

In accordance with one embodiment of the present invention, the subscriber's MO call is a national or international call that is routed through an alternative number from the subscriber's home country, or third country or carrier cloud. In various embodiments of the invention, the SRR service may be used by local subscribers at home network making international calls or an inbound roamer making international call or an outbound roamer making a roaming call (national or international). In this embodiment, the called party can be present either in subscriber's present country or a different country, thus making the MO call either a national roaming call or an international roaming call. For sake of clarity the present invention is explained with international roaming scenarios, however, it will be apparent to a person skilled in the art that this invention will be equally applicable while dealing with all national roaming scenarios.

The Smart Re-Routing (SRR) solution's first routing module is installed in a home network as a SCP for outbound roamers. The SRR solution maintains the following interfaces:

Interface with VLRs in the roaming partner network

Interface with MSCs in the roaming partner network

Interface with GMSC in the deploying network

Interface with international signaling gateways (or STPs that are connected to such gateways) in the deploying network

The SRR service is deployed at edge of roaming and interconnects domains as it enables the operator to capture more termination fees while enhancing the roamers customer experience and potentially, benefit from lower IOT when routing calls back home.

In accordance with an embodiment of the present invention, the SRR solution requires CAMEL partnership between HPMN and VPMN. The SRR solution interfaces with network over CAMEL and ISUP/INAP over SS7 or SIGTRAN. ISUP or INAP is only used for handling calls which have been routed to home network or carrier cloud infrastructure. In yet another embodiment of the present invention, the SRR solution uses SIP or WIN profile of the outbound roamer to re-route the call control. The subscriber's profile may be statically assigned from the HLR of the outbound roamer. Alternatively, the profile is dynamically assigned based on registration attempt of the outbound roamer.

In accordance with various embodiments of the present invention, the SRR solution also support probing of roaming links for capturing subscriber profile parameters. The SRR solution supports updating the subscriber profile in VLR for gaining control of calls in order to perform smart re-routing. The O-CSI is set with SRR's routing module as SCP GT in roaming profile. Alternatively, DCG may be used for setting O-C SI triggers for out-roamers. However, if DCG is used, then probe is also installed. For billing reconciliation, the CDRs with originally dialed number are required at the MSC for billing and rating. The operator's MSC CDRs are to be modified with original called number.

In accordance with all embodiments of the present invention, the SRR service ensures that call made by outbound roamers from the visited network are routed in an optimal manner, with the aim of maximizing the margin that accrues to the home operator. The SRR service leverages Roamware's Carrier Service (RCS) Infrastructure that has partnership with a leading signaling and voice service provider, to re-route the calls via a “Hub” operated within the carrier cloud. The RCS consists of hubs at each partner international carrier and its associated local number presence at various countries. The end-destination of such a call could be the home network or another service provider network within the home country, or a network in a third country. This variation enables the home operator to selectively determine the most optimal cloud-based, based on the overall business value taking into account the various cost/revenue elements.

The SRR service leverages CAMEL partnership is used to bring the call control of outbound roamer's calls to home network. In one case, the operator provisions the O-CSI for all outbound roamers or uses the DCG is to set the O-CSI dynamically. Thereafter, upon origination of any MO or forwarded call, O-CSI is triggered and call control comes to the first routing module deployed at home network. The first routing module gets a temporary DNIS number allocated (from the second routing module) for the call and gets the call routed on the same. This DNIS number actually belongs to the second routing module (i.e., the SRR Hub) falling in desired path of the call. The ISUP call is thus routed via the second routing module that re-synchs the call to the original called number.

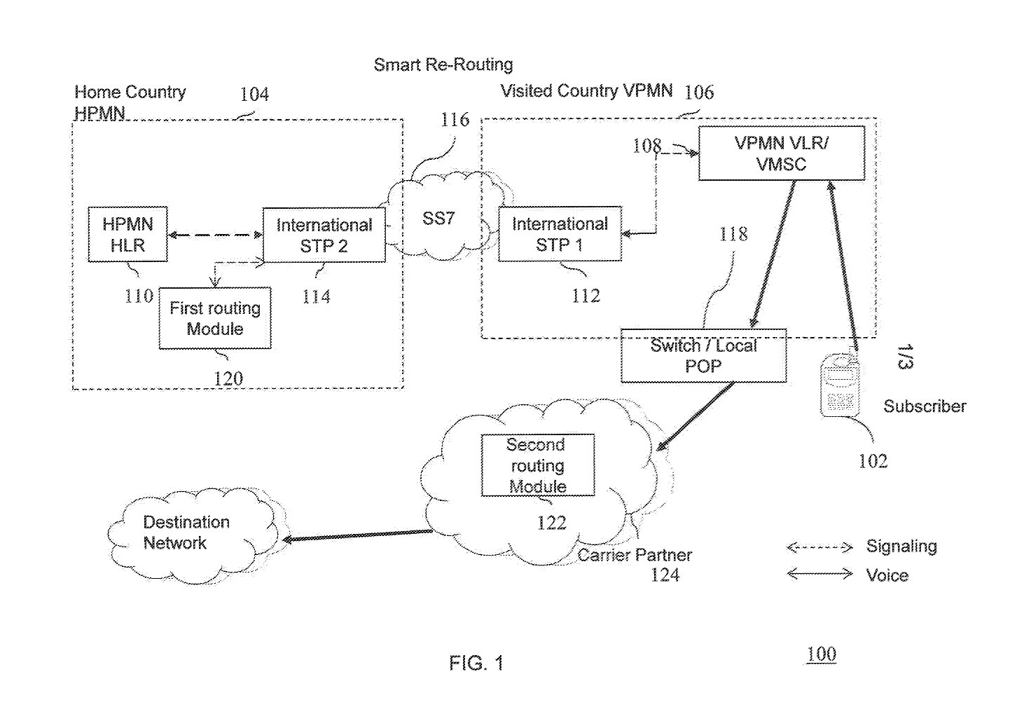

FIG. 1 illustrates a system 100 for implementing Smart Re-Routing (SRR) service, in accordance with an embodiment of the present invention. A subscriber 102 of HPMN 104 (from home country) is roaming in a VPMN 106 (from visiting country). The subscriber 102 is connected to a VPMN VLR 108, when it is roaming outside HPMN 102. In one embodiment of the invention, VPMN VLR 108 is integrated with a VMSC in VPMN 106. Notwithstanding, both VPMN VLR and VMSC may have different logical addresses. Subscriber profile data corresponding to subscriber 102 is stored in HPMN HLR 110. The signaling corresponding to subscriber 102 is routed using an international STP 1 112 at VPMN 106 and international STP 2 114 at HPMN 104. The signaling between HPMN and VPMN 106 is carried using SS7 signaling architecture 116. The signals exchanged between HPMN 104 and VPMN 106 are MAP based signals. Other network elements of HPMN 104 (e.g., MSC/VLR) communicate with various other network elements of VPMN 106 (e.g., HLR, VLR etc.) via the SS7 link. It will also be apparent to a person skilled in the art that various components of HPMN 104 communicate with VPMN 106 using various signaling techniques including, but not limited to, SS7, SIP, IP, ISUP etc.

In accordance with various embodiment of the present invention, VPMN VLR 108 interacts with international STP 1 112 via a switch 118. In one embodiment of the invention, switch 118 is a Local POP (Point-Of-Presence) in VPMN 106 although the Local POP can be in any visit country network or visit region network or any network in the world. The SRR service is handled by a first routing module 120 that resides in HPMN 104 (i.e., the first network) and a second routing module 122 that resides in a carrier partner network 124 (i.e., the second network). It will be apparent to a person skilled in the art that the first routing module 120 is present at the location from where the MO call is controlled. For example, for an outbound roamer, the first routing module 120 is present in first network, i.e., HPMN 104, while for inbound roamer or local subscriber the first routing module 120 is present first network, i.e., VPMN 106. The local POP (i.e. switch) 118 is country specific that is only a switching infrastructure that takes calls on certain DIDs (Direct Inward Dialing) that are local numbers specific to the country (anywhere in the world including visit country, home country or third country) that is associated with that local POP. The routing module 120 may be located at a hub location that can cater to multiple networks' local POP for re-routing the subscriber's outbound calls through SRR service. The second routing module 122 is present in the second network, which could be either a carrier cloud Hub network, or a network from a third country or a network in the visited country or a network from the home country or even the visited network itself. Basically both routing modules can be physically located anywhere in the world although their logical functions are described in this patent.

The representation of first routing module 120 and second routing module 122 in HPMN 104 and carrier partner network 124 respectively, is only exemplary and not limiting. It will be apparent to the person skilled in the art that HPMN 104 and VPMN 106 may follow their own interconnect routes to route calls to any local POP in the world.

In accordance with an embodiment of the present invention, several routing modules can be used in RCS ecosystem that supports geographically redundant gateways around the world. Further several such ecosystems can form a meta-ecosystem. In various embodiments of the present invention, the first routing module 120 routes subscriber 102's MO international call to a called party (in destination network as shown in FIG. 1) through an alternative number that is fetched from the second routing module 122. This called party can be either in a destination network or in home network (HPMN 104) or visiting network (VPMN 106) or a third country different from HPMN 104 or VPMN 106. The subscriber 102's caller ID and the called international number (called party) and subscriber's country (VPMN 104) from where the MO call is initiated is mapped to the alternative number in the first routing module 120 where this mapping is stored. So if subscriber 102 directly dials the alternative number at the country, the call will reach the called party's number.

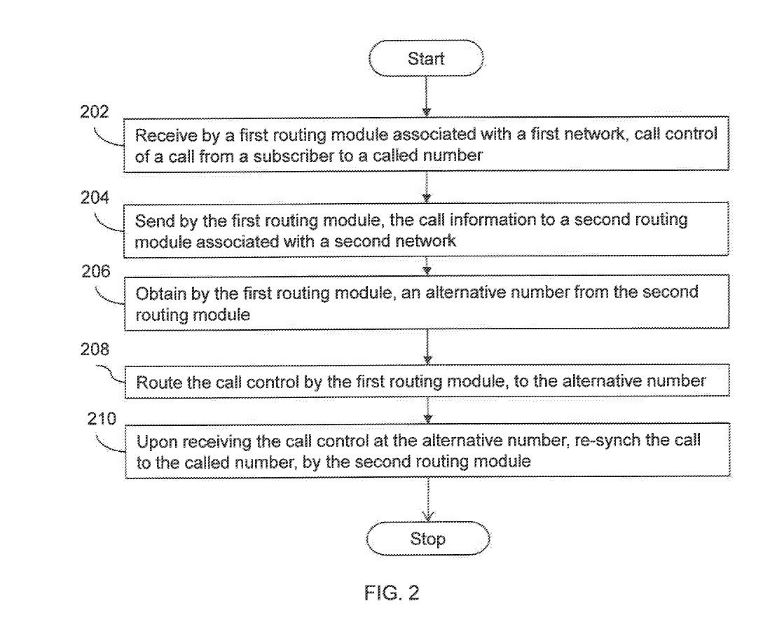

FIG. 2 represents a flowchart depicting method for enabling mobile communication using Smart Re-Routing service, in accordance with an embodiment of the present invention. At step 202, first routing module 120 associated with a first network (HPMN 104) receives the call control of outbound roamer 102's MO call to a called party. At step 204, first routing module 120 sends the call information to a second routing module 122 associated with a second network (carrier partner 124). Thereafter, at step 206, the first routing module 120 obtains an alternative number from the second routing module 122. At step 208, the first routing module 120 routes the call control to the alternative number. Finally, at step 210, upon receipt of call control at the alternative number, the second routing module 122 re-synchs the call to the called party's called number.

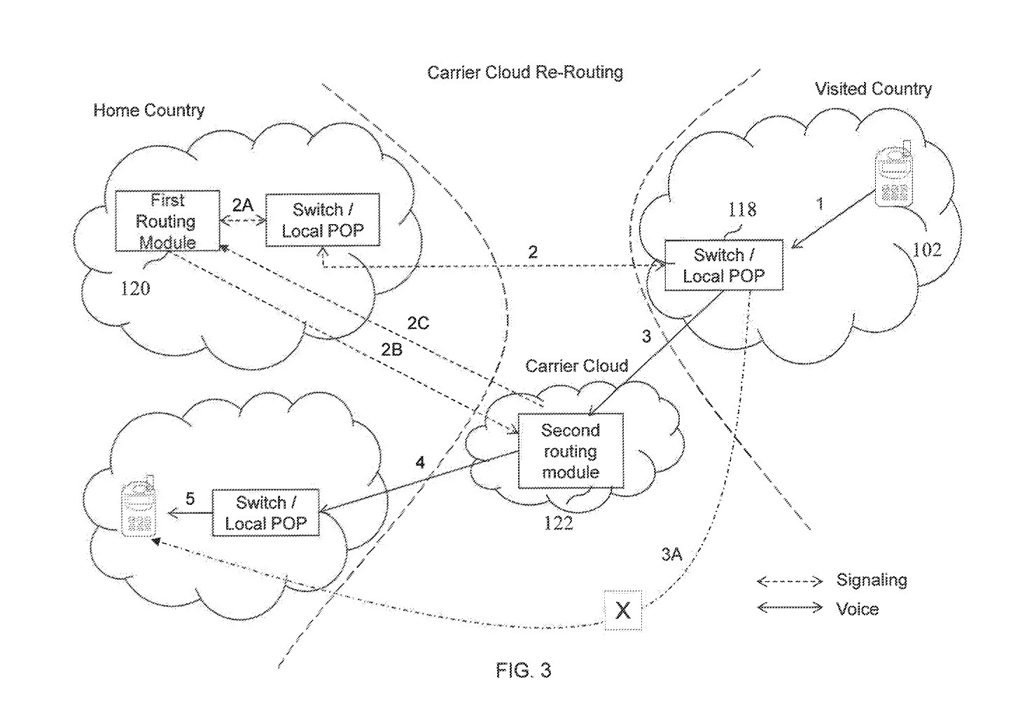

FIG. 3 represents the system for implementing SRR service using carrier cloud re-routing, in accordance with an embodiment of the present invention. In this embodiment of implementing the SRR service, the call re-routing is based on Roamware's partnership with one or several leading signaling/voice carriers each of which will deploy a second routing module and the first routing module can choose which carrier partner or second routing module to work with based on some business logic (e.g. traffic distribution control among carrier partners) on a combination of called number and subscriber location. This embodiment helps to extend the SRR service to an entire ecosystem of the carrier's customer operators. For Roamware these operators totals to more than 220 destinations all around the globe. This mechanism allows the operator to choose a path from the visited network of the roamer to the destination network for the call, for which the home operator has to pay minimum Inter Operator Tariff to the visited operator or allow the home operator to control the quality of the route (e.g. CLI delivery, low latency, low congestion, better voice quality etc) on the outbound roamer's call from the visited operator to the final destination. With multiple local as well as regional point of presence from its partner, the home operator using Roamware's SRR solution is able to route these calls at these points of presence to which the roaming partner would be charging lower Inter Operator Tariff or better quality than if the call was directly routed to the destination network.

The concept is illustrated for a scenario where the called party is in the home country of the calling party, by means of home country rerouting scenario to route a call back to the home network, but the mechanism can also apply to the case of re-routing to another (non-home) network in the home country or even to a network in the third-country.

The process flow in FIG. 3 utilizes Roamware's Re-routing Hub, i.e., second routing module 122 (an in-carrier platform that acts as a centralized number assignment system) in conjunction with the home network based first routing module 120. A call placed by the roamer, i.e., subscriber 102 (at step #1) first results in the CAMEL signaling trigger (IDP connect) being sent to the home network, i.e., HPMN 104 (at step #2), which then performs the required call control actions. Subsequently, the signaling messages are routed to the first routing module 120 (at step #2A), deployed in the HPMN 104. The first routing module 120 thereafter sends (at step #2B) the call information (including the final destination called party number) to the second routing module 122 located in carrier cloud, and in return receives (at step #2C) an alternative number from the second routing module 122. The alternative number is from within the carrier cloud that is reserved by the re-routing hub. This alternative number is then sent back to VPMN 106 as the modified destination number (as a response to step #2). Subsequently, the call is re-routed to the alternative number (at step #3). Once the call reaches the alternative number, the second routing module 122 re-synchs the call to the called number (mobile shown as an example, but it can be any number) at steps #4 and #5. As a result, VPMN 106 routes the call towards the carrier cloud (at step #4 and #5), instead of following the normal procedure of routing the call directly to the destination network (as represented at step #3A by a cross indicating that this step does not occur but is only for representation).

The business case in carrier cloud based routing scenario is based on a substantially lower cost (thereby resulting in a lower TAP charge from VPMN to HPMN) or better quality (CLI, low latency and low congestion, better voice quality etc) of routing from VPMN 106 to the carrier cloud network. This is also supported by the fact that the carrier cloud offers very competitive rates for routing calls to the end destination, which are charged back to the home network. Effectively, the routing via the carrier cloud works out to be cheaper than the IOT between VPMN 106 and the actual destination network. The end-subscriber continues to pay the normal charge for the roaming call, which when coupled with the lower TAP charge (due to the rerouting to the carrier cloud network), gives a higher margin to HPMN 104 operator. The billing of these re-routed calls is reconciled to produce back billing records containing the alternative number.

The above call flow can be supported by a few use case scenarios. Let us assume a subscriber from India is roaming in UK, makes an MO call to Russia. In this case, the home network, HPMN is India, while visited network VPMN is UK and the destination network is a third country Russia. Now the first routing module 120 is deployed in India, while the second routing module 122 could be deployed anywhere in carrier cloud that offers an alternative number. The alternative number could be a number from US, any EU country or any other country. The selection of the alternative number is dependent on which country destination the UK operator has lower IOT. The location of second routing module 122 could be physically the same location from where alternative number is provided, or it could be in a central location which has the capability to receive call control from the alternative number. For example, in this case, a US alternative number is provided assuming that calls to US are having cheaper IOT for the UK operator and hence, the second routing module 122 is also present in US.

In a second scenario, let us assume a local subscriber in India at home network is making an international call to Russia. In this case, the HPMN is India and the first routing module 120 is deployed in India. Again, the alternative number could be selected from US knowing that charge of the IDD leg of calls to US from India are cheaper than the international charges for calls from India to Russia. In this case too, the second routing module 122 could be deployed in US or at a central hub location, say UK.

While the conventional art of smart routing is based on home routing involving one routing module associated with one network, the innovation here involves two routing modules associated with two different networks. The innovation can also be combined with home routing by first routing the call to an alternative number assigned by the second routing module and then have the second routing module route to another alternative number (e.g. a temporary called number) assigned by the first routing module (as in today's art of home routing) and then when the call on the second alternative number (ie. the temporary called number) reaches the home network, the first routing module can take over the call control and resynches the call back to the original called number. In this way, the home operator can benefit from cheaper IOT, better voice quality on a carrier route under its control rather than the VPMN control and at the same time, having the call back to the home network so to allow home operator having a call control (e.g. duration of the call) and international termination margin (as the call is terminated in home network before reaching the final destination).

In accordance with various embodiments of the present invention, the SRR service is deployed for establishing a Termination Ecosystem (TE). The termination ecosystem is applicable for international MO calls of an inbound roamer or local subscriber, made to non-partner network in a country, where another partner network exists and there is a termination asymmetry in international and domestic termination. The termination ecosystem members provide pool of numbers to the SRR platform where the call can be terminated to leverage the termination asymmetry. The pool of numbers allocated is configured to check the actual destination number from the TE-HUB (i.e., SRR platform which is first routing module 120).

The logistics for setting up the Termination Ecosystem include setting up GMSC at the International Gateway to interface with TE-Hub over CAMEL trigger or ISUP loopback for all international calls. The CAMEL triggers carry call details to the TE-Hub. The TE-Hub recognizes the destination network (from CC/NDC of called number) and then provides an alternative number from appropriate pool of a partner network, where the call can be terminated. When the call is terminated on such an alternative number at the partner network, the GMSC of the partner is configured to check for final destination from the TE-Hub (CAMEL/IN trigger or ISUP loopback) and route the call appropriately to the called party (actual final destination).

The present invention is its various embodiments provide multiple advantages to the operator deploying the SRR service. The operator is able to garner the termination fee inflow and reap the benefits of substantially low tariffs for re-routing calls to networks within the home country. This re-routing typically yield higher margins based on tariff differences for calls routed to home and third countries. The operator is also able to assure delivery of CLI and RDN, especially for calls routed back to the home country, by compensating for any possible loss of the CLI and RDN when the call is connected from the visited to the home network.

This SRR service is also advantageous to the subscriber. The subscriber remains blissfully unaware of how the call is routed, both in terms of duration for call connection and tariff. In some cases, to further strengthen the business case, the operator may decide to pass on part of cost savings to subscriber by providing lower tariffs for these re-routed calls.

The SRR service can also be similarly applied for international calls by local subscribers or inbound roamers (rather than outbound roamers). The basic principle is the same where such international call controls maybe rerouted to an alternative number where the call is resynched back to the original-called-number so to either explore the arbitrage of the different routes or quality reason (e.g. CLI guarantee).

It will be apparent to a person skilled in the art, that the present invention can also be applied to Code Division Multiple Access (CDMA)/American National Standards Institute #41D (ANSI-41D), and various other technologies such as, but not limited to, VoIP, WiFi, 3GSM and inter-standard roaming. In one exemplary case, a CDMA outbound roamer travels with an HPMN CDMA handset. In another exemplary case, the CDMA outbound roamer travels with an HPMN GSM SIM and a GSM handset. In yet another exemplary case, GSM outbound roamer travels with an HPMN CDMA RUIM and a CDMA handset. To support these variations, system 100 will have a separate SS7 and network interfaces, corresponding to both the HPMN and VPMN networks. It will also be apparent to a person skilled in the art that these two interfaces in different directions may not have to be the same technologies. Moreover, there could be multiple types of interface in both directions.

An exemplary list of the mapping between GSM MAP and ANSI-41D is described in the table below as a reference.

| GSM MAP | ANSI-41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTING REQUEST |

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

### Other Variations

Provided above for the edification of those of ordinary skill in the art, and not as a limitation on the scope of the invention, are detailed illustrations of a scheme for proactive roaming tests, discoveries of roaming partner services and discoveries of frauds in roaming using simulated roaming traffic. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

### Technical References

GSM 902 on MAP specification
Digital cellular telecommunications system (Phase 2+)
Mobile Application Part (MAP) Specification
(3GPP TS 09.02 version 7.9.0 Release 1998)
GSM 340 on SMS
Digital cellular telecommunications system (Phase 2+)
Technical realization of the Short Message Service (SMS)
(GSM 03.40 version 7.4.0 Release 1998)
GSM 378 on CAMEL,
GSM 978 on CAMEL Application Protocol,
GSM 379 on CAMEL Support of Optimal Routing (SOR),
GSM 318 on CAMEL Basic Call Handling
ITU-T Recommendation Q.1214 (1995), Distributed functional plane for intelligent network CS-1,
ITU-T Recommendation Q.1218 (1995), Interface Recommendation for intelligent network CS-1,
ITU-T Recommendation Q.762 (1999), Signaling system No. 7-ISDN user part general functions of messages and signals,
ITU-T Recommendation Q.763 (1999), Signaling system No. 7-ISDN user part formats and codes,
ITU-T Recommendation Q.764 (1999), Signaling system No. 7-ISDN user part signaling procedures,
ITU-T Recommendation Q.765 (1998), Signaling system No. 7-Application transport mechanism,
ITU-T Recommendation Q.766 (1993), Performance objectives in the integrated services digital network application,
ITU-T Recommendation Q.769.1 (1999), Signaling system No. 7-ISDN user part enhancements for the support of Number Portability

APPENDIX

| Acronym | Description |
|---|---|
| 3G | Third generation of mobile |
| ACM | ISUP Address Completion Message |
| ANM | ISUP Answer Message |
| ANSI-41 | American National Standards Institute #41 |
| ATI | Any Time Interrogation |
| BCSM | Basic Call State Model |
| BSC | Base Station Controller |
| BOIC | Barring Outgoing International Calls |
| BOIC-EX- | Barring Outgoing International Calls except to home |
| Home | country |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CDR | Call Detail Record |
| CF | Call Forwarding |
| CgPA | Calling Party Address |
| CIC | Circuit Identification Code |
| CLI | Calling Line Identification |
| CSD | Circuit Switched Data |
| CSI | Camel Subscription Information |
| DPC | Destination Point Code |
| DSD | Delete Subscriber Data |
| DTMF | Dual Tone Multi-Frequency |
| ERB | CAP Event Report Basic call state model |
| EU | European Union |
| FPMN | Friendly Public Mobile Network |
| FTN | Forward-To-Number |
| GLR | Gateway Location Register |
| GGSN | Gateway GPRS Support Node |
| GMSC | Gateway MSC |
| GMSC-F | GMSC in FPMN |
| GMSC-H | GMSC in HPMN |
| GPRS | General Packet Radio System |
| GSM | Global System for Mobile |
| GSMA | GSM Association |
| GSM SSF | GSM Service Switching Function |
| GsmSCF | GSM Service Control Function |
| GT | Global Title |
| GTP | GPRS Tunnel Protocol |
| HLR | Home Location Register |
| HPMN | Home Public Mobile Network |
| IN | Intelligent Network |
| IOT | Inter-Operator Tariff |
| GTT | Global Title Translation |
| IAM | Initial Address Message |
| IDP | Initial DP IN/CAP message |
| IDD | International Direct Dial |
| IMSI | International Mobile Subscriber Identity |
| IMSI-H | HPMN IMSI |
| IN | Intelligent Network |
| INAP | Intelligent Network Application Part |
| INE | Interrogating Network Entity |
| IP | Internet Protocol |
| IREG | International Roaming Expert Group |
| IRS | International Revenue Share |
| ISC | International Service Carrier |
| ISD | MAP Insert Subscriber Data |
| ISG | International Signal Gateway |
| IST | Immediate Service Termination |
| ISTP | International STP |
| ISTP-F | ISTP connected to FPMN STP |
| ISTP-H | ISTP connected to HPMN STP |
| ISUP | ISDN User Part |
| ITPT | Inbound Test Profile Initiation |
| ITR | Inbound Traffic Redirection |
| IVR | Interactive Voice Response |
| LU | Location Update |
| LUP | MAP Location Update |
| MAP | Mobile Application Part |
| MCC | Mobile Country Code |
| MCC | Mobile Country Code |
| MD | Missing Data |
| ME | Mobile Equipment |
| MGT | Mobile Global Title |
| MMS | Multimedia Message Service |
| MMSC | Multimedia Message Service Center |
| MMSC-F | FPMN MMSC |
| MMSC-H | HPMN MMSC |
| MNC | Mobile Network Code |
| MNP | Mobile Number Portability |
| MO | Mobile Originated |
| MOS | Mean Opinion Score |
| MS | Mobile Station |
| MSC | Mobile Switching Center |
| MSISDN | Mobile Station International Subscriber Directory Number |
| MSISDN-F | FPMN MSISDN |
| MSISDN-H | HPMN MSISDN |
| MSRN | Mobile Station Roaming Number |
| MSRN-F | FPMN MSRN |
| MSRN-H | HPMN MSRN |
| MT | Mobile Terminated |
| MTP | Message Transfer Part |
| NDC | National Dialing Code |
| NP | Numbering Plan |
| NPI | Numbering Plan Indicator |
| NRTRDE | Near Real Time Roaming Data Exchange |
| O-CSI | Originating CAMEL Subscription Information |
| OCN | Original Called Number |
| ODB | Operator Determined Barring |
| OPC | Origination Point Code |
| OR | Optimal Routing |
| ORLCF | Optimal Routing for Late Call Forwarding |
| OTA | Over The Air |
| OTPI | Outbound Test Profile Initiation |
| PDP | Protocol Data Packet |
| PDN | Packet Data Network |
| PDU | Packet Data Unit |
| PRN | MAP Provide Roaming Number |
| PSI | MAP Provide Subscriber Information |
| QoS | Quality of Service |
| RAEX | Roaming Agreement EXchange |
| RI | Routing Indicator |
| RIS | Roaming Intelligence System |
| RDN | Redirecting Number |
| RNA | Roaming Not Allowed |
| RR | Roaming Restricted due to unsupported feature |
| RRB | CAP Request Report Basic call state model |
| RSD | Restore Data |
| RTP | Real-Time Transport Protocol |
| SAI | Send Authentication Info |
| SC | Short Code |
| SCA | Smart Call Assistant |
| SCCP | Signal Connection Control part |
| SCP | Signaling Control Point |
| SF | System Failure |
| SG | Signaling Gateway |
| SGSN | Serving GPRS Support Node |
| SGSN-F | FPMN SGSN |
| SIM | Subscriber Identity Module |
| SIGTRAN | Signaling Transport Protocol |
| SME | Short Message Entity |
| SM-RP-UI | Short Message Relay Protocol User Information |
| SMS | Short Message Service |
| SMSC | Short Message Service Center |
| SMSC-F | FPMN SMSC |
| SMSC-H | HPMN SMSC |
| SoR | Steering of Roaming |
| SPC | Signal Point Code |
| SRI | MAP Send Routing Information |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TADIG | Transferred Account Data Interchange Group |
| TAP | Transferred Account Procedure |
| TCAP | Transaction Capabilities Application Part |
| VT-CSI | Visited Terminating CAMEL Service Information |
| TP | SMS Transport Protocol |
| TR | Traffic Redirection |
| TS | Traffic Steering |
| TT | Translation Type |
| UD | User Data |
| UDH | User Data Header |
| UDHI | User Data Header Indicator |
| USSD | Unstructured Supplementary Service Data |
| VAS | Value Added Service |
| VIP | Very Important Person |
| VLR | Visited Location Register |
| VLR-F | FPMN VLR |
| VLR-H | HPMN VLR |
| VLR-V | VPMN VLR |
| VMSC | Visited Mobile Switching Center |
| VoIP | Voice over IP |
| VPMN | Visited Public Mobile Network |
| ATI | Access Transport Information |
| UDV | Unexpected Data Value |
| USI | User Service Information |
| WAP | Wireless Access Protocol |

1. A method for mobile communication, the method comprising:
receiving by a first routing module, call control of a call from a subscriber to a called number, wherein the first routing module is associated with a first network;
sending by the first routing module, the call information to a second routing module, wherein the second routing module is associated with a second network;
obtaining by the first routing module, an alternative number from the second routing module;
routing the call control by the first routing module, to the alternative number; and
upon receiving the call control at the alternative number, re-synching the call to the called number, by the second routing module.

2. The method of claim 1, wherein the call control received by at least one of the first routing module and the second routing module using one of a CAMEL, SIP, WIN, IN/INAP, ISUP protocols.

3. The method of claim 1, wherein the call control is received at the first routing module, by a statically configured profile in the HLR of the subscriber.

4. The method of claim 1, wherein the call control is received at the first routing module by a dynamically configured profile at the visited network of the subscriber.

5. The method of claim 1, wherein the alternative number is a number of one of the visited country of the subscriber, the home country of the subscriber and a 3^{rd} country other than home country and visited country of the subscriber.

6. The method of claim 1, wherein the call information sent by the first routing module to the second routing module comprises CLI, Called Number and optionally any other parameters of the call received by the first routing module, using one of an IP, SS7 bearers.

7. The method of claim 1, wherein the second routing module returns the alternative number to the first routing module based on the location of the caller and the called number, using one of an IP, SS7 bearers.

8. The method of claim 1, wherein the first routing module resides at the same location as the second routing module at the second network.

9. The method of claim 1, wherein the first routing module is integrated with the second routing module.

10. The method of claim 1, wherein billing records on the alternate number is reconciled to produce back billing records containing the called number.

11. The method of claim 1, wherein the first routing module decides to route the call to the alternative number such that there is an arbitrage between original route and new route.

12. The method of claim 1, where the first routing module selects a new second routing module located in a new network other than second network, based on selection logic.

13. The method of claim 12, where the selection logic where the selection logic is based on a combination of caller, caller number, location of the caller and distribution control.

14. The method of claim 1, wherein different first networks share the different second routing modules of the different second networks.

15. The method of claim 1, where the first routing module sends the second routing module some call information including a temporary called number (instead of the original called number) to request an alternative number from the second routing module and upon receiving call control on the alternative number, the second routing module routes the call control to the temporary called number

16. The method of claim 15, upon receiving call control on the temporary called number, the first routing module routes the call control back to the original called number

17. A system for mobile communication, the system comprising:
a first routing module associated with at a first network that receives call control of a subscriber's call to a call number, the first routing module further routes the call to an alternative number upon receiving the alternative number from a second routing module associated with a second network, upon sending the call information of the call from the first routing module to the second routing module; and
the second routing module further re-synchs the call to the called number upon receiving call control at the alternative number.

18. The system of claim 17, wherein at least one of the first routing module and the second routing module receives the call control using one of a CAMEL, SIP, WIN, ISUP, IN/INAP protocols.

19. The system of claim 17, wherein the call control is received at the first routing module by statically configuring the profile in the HLR of the subscriber.

20. The system of claim 17, wherein the first routing module dynamically assigns the call control profile to the visited network based on registration of the caller at the visited network.

21. The system of claim 17, wherein the alternative number is a number of one of the visited country, the home country and a third country other than home country and visited country of the subscriber.

22. The system of claim 17, wherein the call information sent by the first routing module to the second routing module comprises CLI, called number and optionally other parameters of the call.

23. The system of claim 17, wherein the second routing module returns the alternative number to the first routing module based on the location of the caller and the called number, using one of an IP, SS7 bearers.

24. The system of claim 17, wherein the first routing module resides at the same location as the second routing module at the second network.

25. The system of claim 17, wherein the first routing module is integrated with the second routing module.

26. The system of claim 17, wherein the first routing module reconciles the billing records on the alternative number to produce back billing records containing the called number.

27. The system of claim 17, wherein the first routing module decide to route the call control to the alternative number based on there is an arbitrage between original route and new route.

28. The system of claim 17, where the first routing module selects a new second routing module based on selection logic.

29. The system of claim 28, wherein the selection logic is based on a combination of caller number, called number, location of the caller, and distribution control.

30. The system of claim 17, wherein different first networks share the different second routing modules of the different second networks.

31. The system of claim 17, where the first routing module sends the second routing module some call information including a temporary called number (instead of the original called number) to request an alternative number from the second routing module and upon receiving call control on the alternative number, the second routing module routes the call control to the temporary called number

32. The system of claim 31, upon receiving call control on the temporary called number, the first routing module routes the call control back to the original called number
